(19) United States
(12) Patent Application Publication
(10) Pub. No.: US 2009/0160746 A1
(43) Pub. Date: Jun. 25, 2009

(54) Light Valve Display Using Low Resolution Programmable Color Backlighting

(76) Inventor: Istvan Gorog, Lancaster, PA (US)

Correspondence Address: Thomson Licensing LLC, P.O. Box 5312, Two Independence Way, PRINCETON, NJ, 08543-5312, US

(21) Appl. No.: 12/083,452

(22) PCT Filed: Sep. 14, 2007
(86) PCT No.: PCT/US07/20019

§ 371 Date: Apr. 11, 2008

Related U.S. Application Data
(60) Provisional application No. 60/844,692, filed on Sep. 15, 2006.
(60) Provisional application No. 60/873,237, filed on Dec. 6, 2006.
(60) Provisional application No. 60/921,569, filed on Apr. 3, 2007.

(51) Int. Cl. G09G 3/36

(52) U.S. Cl. 345/88

(57) ABSTRACT

A display comprises a front-end component having a matrix of neutral light valves that defines the resolution of the display. A backlight unit provides backlighting for the front-end component and has a plurality of individual elements grouped into repeat units, wherein the individual elements in the repeat units differ in color and the repeat units have a resolution less than the display resolution. All individual elements in individual repeat units are capable of simultaneously emitting light incident on more than one neutral light valve.

### RELATED APPLICATIONS

This application claims priority to U.S. Provisional Patent Application Ser. No. 60/844,692 entitled “Simultaneous Color Intelligent Backlight with Luminescence Controlling LCD,” filed on Sep. 15, 2006, U.S. Provisional Patent Application Ser. No. 60/873,237 entitled “Display System Utilizing Simultaneous Color Intelligent Backlight Combined with Luminescence Controlling Shutter,” filed on Dec. 6, 2006, and U.S. Provisional Patent Application Ser. No. 60/921,569 entitled “High Efficiency Display System,” filed on Apr. 3, 2007 which are hereby incorporated by reference in their entirety.

### FIELD OF INVENTION

The invention relates to liquid crystal displays and other light valve displays having intelligent backlighting.

### BACKGROUND OF THE INVENTION

Liquid crystal displays (LCDs) commonly utilize cold cathode florescent lights (CCFL) to back-illuminate the LCD panel with white light. LCD panel pixels are subdivided into red, green, and blue (R,G,B) sub-pixels, wherein each sub-pixel is equipped with a corresponding color filter. A known LCD is shown in FIG. 1. The backlighting lamps 58 are positioned before a diffuser 51 of the LCD front end component 60. Following the diffuser 51 in the LCD front end component 60 is a polarizer 52 and a circuit plate 53 having address circuits and associated surface pixel electrodes. The device further includes the liquid crystal material (LC) 54 positioned after the circuit plate 53. The LCD display also includes a second glass plate 55 also supporting surface electrodes, a color filter 59, a second polarizer 56 and a surface treatment film 57, as shown and ordered in FIG. 1.

This conventional LCD suffers from three drawbacks. The first is the optical efficiency of the LCD panel is substantially reduced as a result of the filtering out of the unwanted color components from the white light by the filters associated with the sub-pixels. The second is excessive power consumption by conventional backlighting. The third is that due to the sample and hold nature of the LCD itself, motion artifacts, specifically motion smearing, occurs. So, even though LCDs provide excellent spatial resolution with CCFLs, the temporal motion response is poor due to the sample and hold effect associated with the requirement that with the commonly continuous “ON” illumination provided by CCFL, the LCD pixel shutters must be kept “OPEN” for the entire frame period, or as large a fraction thereof as possible, in order to obtain maximum optical efficiency and brightness.

An approach previously proposed to overcome these problems utilizes field sequential color provided by fast backlighting that illuminates the monochrome LCD without color filters. Such field sequential systems produce noticeable color break up associated with moving objects in the scene and/or eye movements of the viewer. Further, they also require fast switching light valves coupled with fast switching backlighting.

Although public acceptance of conventional LCDs has been very positive, a need exists for a display that overcomes these problems and provides improved motion response and improved optical efficiency.

### SUMMARY OF THE INVENTION

A display comprises a front-end component having a plurality of neutral light valves, the neutral light valves defining the display resolution, and a backlight unit having plurality of individual elements grouped into repeat units, the individual elements in the repeat units differ in color, the repeat units have a resolution less than the display resolution, the individual elements in individual repeat units emit light in a non-color sequential manner incident on more than one neutral light valve. The display further comprises a low pass-filter that receives and filters a full resolution color RGB information of video to produce filtered low resolution color information and a scaled backlight drive receives the filtered low resolution color signal and scales a local color components by a local scaling parameter, the scaled backlight drive correlates a dominant local low resolution color information to maximum possible luminance for the color components and accordingly drives the individual elements in repeat units.

### BRIEF DESCRIPTION OF THE DRAWINGS

FIG. 1 is a sectional view of an existing liquid crystal display (LCD) with backlight lamps.

FIG. 2 is a sectional view of a display with multicolor backlighting according to the invention.

FIG. 3 is a sectional view of a field emission device (FED) used for backlighting an LCD according to the invention.

FIG. 4 is another sectional view of a field emission device used for backlighting an LCD according to the invention.

FIG. 5 is a plan view of a plurality of phosphor elements in the field emission device according to the invention.

FIG. 6 is a schematic view of signal processing of the LCD with multicolor backlighting according to the invention.

FIG. 7 is a schematic view of another signal processing scheme of the LCD with multicolor backlighting according to the invention.

FIG. 8 is a schematic view of an additional signal processing scheme of the LCD with multicolor backlighting according to the invention.

FIG. 9 is a representation of the low resolution plan view image of color content of a frame of video from tricolor backlighting according to the invention.

FIG. 10 is a representation of the full resolution plan view image of luminance content from the same frame of video used in FIG. 9 from the luminance controlling front-end with neutral light valves according to the invention.

FIG. 11 is a representation of the resulting full resolution viewable color image after combining the luminance controlling front-end and color content controlling backlighting components for the frame of video used in FIGS. 9 and 10.

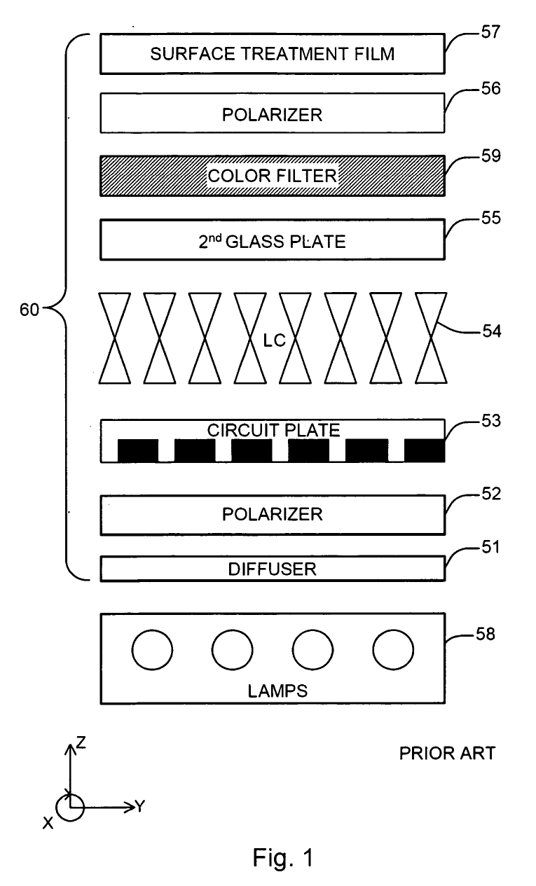

### DETAILED DESCRIPTION OF THE PREFERRED EMBODIMENTS

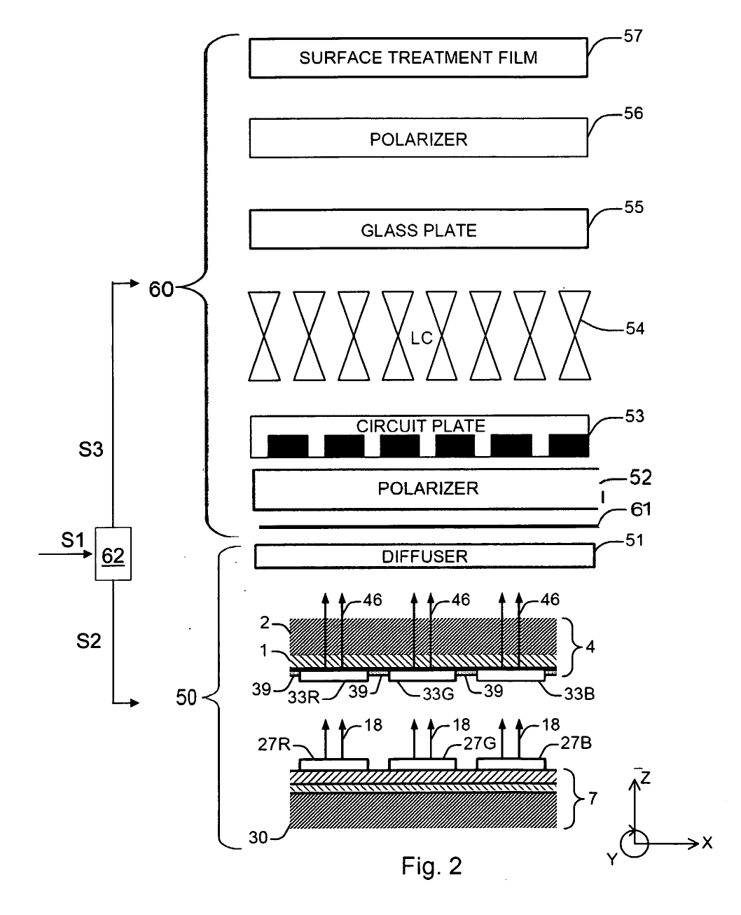

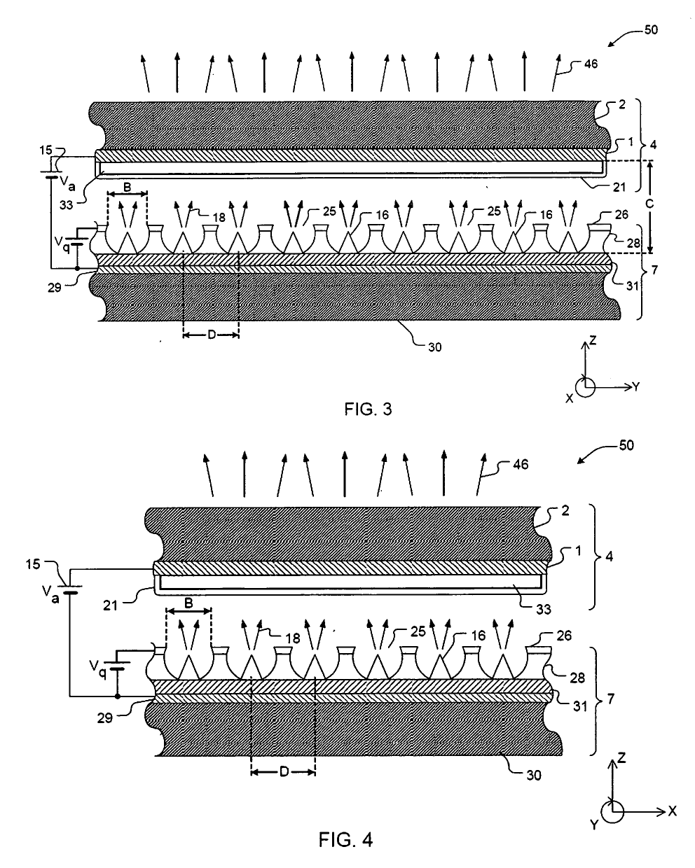

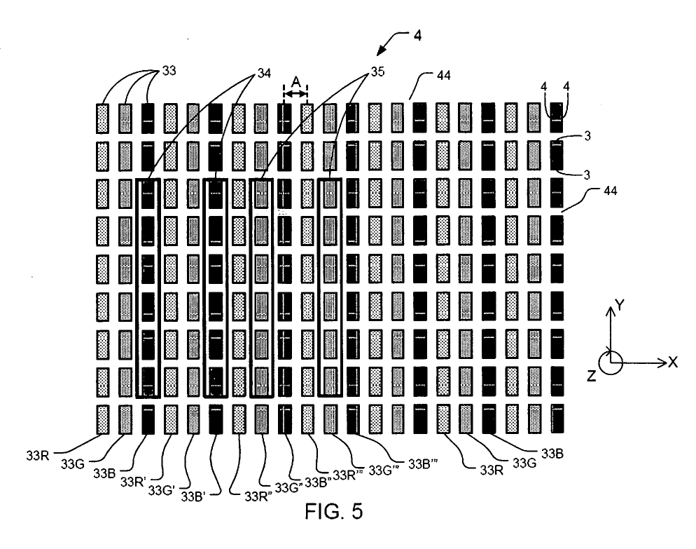

An exemplary embodiment of the present invention will be described with reference to the accompanying figures. FIG. 2 shows a cross sectional view of an exemplary LCD (liquid crystal display) having an LCD front end component 60 and a field emitting device backlight (or low resolution intelligent programmable backlight operated in non-color sequential mode, preferably simultaneous mode) 50. In the exemplary embodiment, the individual phosphor elements 33 run in vertical stripes or patched as shown in FIG. 5; however, the invention does include embodiments where the phosphor elements 33 run horizontally and where the phosphor elements of a given color run continuously. FIGS. 3 and 4 show different cross sectional views of the field emitting device (FED) backlight 50 according to the exemplary embodiment of the invention. In the figures, the Y-axis is the vertical axis and the X-axis is the horizontal axis. As will be described, having the individual phosphor elements permits intelligent backlighting for the LCD.

The FED backlight 50 has a cathode 7 comprising a plurality of emitters 16 arranged in an array that emit electrons 18 due to an electric field created in the cathode 7. These electrons 18 are projected toward the anode 4. The anode 4 can comprise a glass substrate 2, having a transparent conductor 1 deposited thereon. The individual phosphor elements 33 can then be applied to the transparent conductor 1 and can be separated from one another. The transparent conductor 1 can be indium tin oxide. The phosphor elements 33 can comprise red phosphor (33R), green phosphor (33G), and blue phosphor (33B), as arranged FIG. 5.

The operation of the FED backlight 50 involves the electrons 18 from the plurality of emitters 16 in a cathode 7 striking phosphor elements 33 on an anode plate 4 and causing photon emission 46. A grouping of emitter cells 27R, 27G, 27B represented in FIG. 2 correspond to individual phosphor elements 33. Potential 15 is applied to the anode 4 during display operation. To emit electrons 18 from particular array emitter apertures 25, a gate potential Vq is applied to specific gates 26 which can be supported on dielectric material 28. As shown in FIGS. 3 and 4, a plurality of gates 26 (and consequently a plurality of emitter cells) can be used in one phosphor element 33.

While the FED structure shown in FIG. 2 includes a black matrix 39, a commercial quality LCD display with the FED backlighting is attainable without the black matrix. The black matrix will, however, still provide some nominal improvement in black fields and in contrast. Appropriate x-y addressing of the cathode plate allows programmable emission of electrons from a cold cathode, most conveniently constructed with carbon nanotube (CNT) technology. A key advantage of FEDs is that their programmability is achieved with low voltage and low current signals applied in an x-y matrix manner to the cathode structure. Furthermore, as a consequence of the inherent non-linearity of the field emission phenomenon, no active devices are needed to be incorporated as switches at the x-y junctions. A further advantage of FEDs is that the power source for the emitted light is a simple DC power supply that in this application is preferably operated in the 10-20 kV range. A suitable FED for intelligent backlights can comprise 10-1,000 individually programmable rows and approximately the same number of columns. In the example FED shown in FIG. 5, each column has only one phosphor type and the phosphor colors cycle along each row. In this case, the system can have vertical programmability, wherein columns can be turned on in their entirety. Alternatively, each row can comprise a single phosphor color. In this case horizontal programmability is provided, wherein a row can be turned on in its entirety. For the backlight according to the invention, suitable pitches A (in FIG. 5) between the individual phosphor elements 33 can be dictated by the desired performance requirement of the LCD display. An example dimension of the pitch A can be several millimeters (e.g., 1-5 mm). As shown in FIGS. 3 and 4, an individual phosphor element 33 can have a plurality of emitter cells each with array emitter apertures 25 having opening dimension B, as shown in FIG. 3. Suitable opening dimension B values can be about 10 microns. The opening dimension B in FIGS. 3 and 4 does not necessarily have to be the same value. The pitch of emitter cells D can be around 15-30 microns. The pitch of emitter cells D in FIGS. 3 and 4 does not necessarily have to be the same value. Regarding the spacing C between the anode plate 4 and the cathode plate 7, it turns out that a spacing C from 1 millimeter to several millimeters works very well for the FED in a backlight mode in the LCD display. Preferably, the spacing C is 1-5 mm, which helps to maintain a very thin display. The spreading of electrons due to space charge and emission angle associated with these spacings turns out to not be detrimental to the color performance of backlight when the pitch A is larger than about 1 mm. In other words, the LCD has a relatively low resolution requirement for the backlight even when the intelligent backlighting is used. As such, electron spreading between the anode and the cathode plates is of no significant concern. The carbon nanotube FED can provide excellent light output subject to visible graininess due to emission non-uniformities. In the disclosed device, the undesirable consequences of such emission non-uniformities are rendered imperceptible through the use of an appropriate diffuser between the FED backlight and the liquid crystal device. For example, in an FED backlight employing 300 individually addressable rows one could assign 100 of these rows to each of the three colors—Red, Green, Blue, such that upon activating the appropriate control signals in a non-color sequential manner (preferably simultaneous manner) such that the Red, Green, and Blue phosphor elements from the anode plate are lit up provided all of the colors are required for the image on the screen. FIG. 5 shows an example array of the FED device in plan view of a hypothetical situation in which blue backlight is desired at a certain time in several rows of two adjacent colored groupings represented as first block 34 (i.e., Red 33R, Green 33G, Blue 33B and Red 33R′, Green 33G′, Blue 33B′) and green backlighting is desired next in time in the same rows but the next two adjacent colored groupings represented as second block 35 (i.e., Red 33R″, Green 33G″, Blue 33B″ and Red 33R′″, Green 33G′″, Blue 33B′″). Note that in the example shown in FIG. 5, only 6 phosphor elements 33 in a column are shown as activated at a certain time; however, the display can be designed and operated to have the entire column or fraction thereof in the FED backlight or some other programmable multicolor backlighting activated when such color is needed in a particular region of the screen in the LCD.

A key feature of the invention is the simultaneous use of tri-color CRT standard fast phosphor materials which have decay times significantly shorter than a frame time. Such use enables the display of motion images without motion response problems. Thus, a novel LCD TV can be constructed by replacing the continuously “ON” or “scrolling” backlight units with “FAST” lamps and color filters with a low resolution FED having tri-color CRT phosphor materials. This way CRT-like motion response can be achieved with LCD front-ends (without color filters) operated in an appropriate synchronization with fast backlighting having the appropriate tricolor content. This is a significant advantage over a fast backlight unit with color filters, because the display according to the invention will not waste as much light as a system with color filters. Such systems with color filters waste more than two-thirds of the backlighting incident on the LCD panel.

The brightness of the FED backlight 50 can be greatly enhanced by the presence of thin, reflective metal film 21 on the cathode side of the phosphor. Essentially, the reflective metal film 21 can double the light 46 observed by the viewer. The reason is that the reflective metal film 21 reflects the portion of the light emitted toward the cathode plate so that upon reflection it propagates away from the cathode 7 toward the viewer.

As shown in FIG. 2, the LCD display according to the invention is generally intended to include the polarizer 52, which can be after the diffuser 51. Following the polarizer 52 is a circuit plate 53. LCD front end component 60 can include additional brightness enhancement elements 61 positioned before the polarizer 52 such as a Vikuiti™ optical film made by 3M which increases the brightness of liquid crystal displays (LCDs) by recycling otherwise unused light (such as that is absorbed by the polarizer) and optimizing the angle of the light incident on the liquid crystal. The LCD further includes the liquid crystal materials (LC) 54 positioned after the circuit plate 53. The LCD display also includes a second glass plate 55, a second polarizer 56 and a surface treatment film 57, as shown and ordered in FIG. 2. Regarding the emitters 16 shown in FIGS. 3 and 4, they are shown as being conical microtips emitters. However, carbon nanotubes emitters are preferred. Carbon nanotube cathodes can be effective in FEDs operating at anode potential of 10 kV or greater in the pixel resolution range of 1 mm and larger. A low resolution FED with an appropriate diffuser 52 provides a substantially locally uniform backlight for the LCD display. The diffuser can be part of the field emitting device backlight. Low resolution implies that a specific phosphor element or a specific repeat unit of phosphor elements are not exclusive to a specific LCD pixel. A feature of the invention is that the plurality of the individual colors from the different phosphor elements 33 can pass through an individual LCD pixel having but one LCD cell, which can provide white light, green light, red light, blue light, or combinations thereof when appropriate phosphor elements 33 are activated and light therefrom is appropriately diffused in the vicinity of the LCD pixel.

FIG. 2 also shows controller 62 which receives video signal S1 such as HDTV signals. The controller 62 end converts video signal S1 to LCD drive luminance controller signal S3 (monochrome luminance control signal) and FED drive color controller signal S2 (tricolor input and control signal).

A feature of the invention is that the backlight can be a programmable FED structure, which is referred to as being an intelligent backlight. In the context of this invention, this means that the FED selectively provides specific simultaneous different colored light to specific regions on the screen. This is a benefit because the light is coordinated with the activation and deactivation of the various liquid crystal cell regions. By the FED backlights being programmable, the LCD can achieve good black levels, wide dynamic range, and blur-free motion rendition. Further, the novel combination of a low resolution color FED with simultaneous color emission and a high resolution monochrome LCD panel without color filters can display HDTV images with good luminous efficiency, good motion response, in a cost effective device configuration. To appreciate the benefits of the invention, it is important to understand that the basic (NTSC) color television system is based on the perceptual response of human vision, which is that color information is perceived by humans at much lower spatial resolution than is luminance (brightness) information. In NTSC practice it is not unusual to limit the color information to less than the standardized color bandwidth that itself was substantially less than the standardized luminance bandwidth.

Taking advantage of the human vision, a preferred controller algorithm for this invention is as follows:

Step 1. Analyze the incoming signal to determine from video signal S1 the color content, i.e., the luminance ratios of red (R) to green (G) to blue (B) for each pixel and color sub-pixel of the simultaneous backlight unit (SCIBLU). For white, an exemplary primary system is approximately R:G:B=25:65:10.

Step 2. Based on step 1, set FED drive color controller signal S2 such that the dominant primary(ies) (defining the hue) is (are) at 100% of its (their) white value, and the other(s) is (are) reduced to match the local colorimetric requirement of the signal S1. For example, if the local hue is dominated by R, set FED drive color controller signal S2 for the selected sub-pixel of the SCIBLU to the maximum R value and adjust G and B to a reduced value as required by the colorimetric match. Similarly, if the local colorimetry dictates white, set all three sub-pixels R, G, and B to their maximum value. Accordingly, all SCIBLU pixels will be so programmed by FED drive color controller signal S2 that each and every pixel will have one or two or three of its sub-pixels at the maximum value and zero, one, or two sub-pixel intensities (luminous output) reduced to establish local colorimetric match as specified by S1. Because S1 typically specifies its R, G, B content at full resolution, appropriate local averaging of the color content can be required to obtain the lower resolution color signal (i.e. FED drive color controller signal S2).

Step 3. Derive LCD drive luminance controller signal S3 from S1. For a white pixel the LCD drive luminance controller signal S3, follows directly the luminance of S1 for the selected LCD pixel. For example, if 50% white is required, the local LCD pixel is set to 50% transmission. When the luminance of S1 for the selected LCD pixel is 25% of the maximum and the color content is pure R, set the local LCD pixel to 100% transmission, with the exemplary primary system of R:G:B=25:65:10. In general, one should scale the LCD transmission in proportion to the dominant primary content of S1. The incoming signal S1 has R, G, and B components for each pixel. Each of these can be at some level between 0% and 100% (or at value between 0 and 255 for an 8-bit system). After determining which primary is at the highest level and what is the value of that level, the pixel transmission of the monochrome LCD is set at that value. For example, if R and G are both at a value 121 and G<121, the LCD transmission at the selected pixel is set at value 121. The forgoing assumes that appropriate gamma correction has been taken care of in generating the signal S1.

Another aspect of the invention is scaling the SCIBU output to optimize for ambient light and light and/or dark scenes. Such scaling can be done locally in a 2D manner, locally in a 1D manner, or globally in 0D manner.

General considerations of human image processing are paramount to understanding the significance and effectiveness of the invention. In this light, image transmission and display are primarily analyzed in terms of the tri-stimulus model. In the context of this model, a color image is viewed as a frame, or sequences of frames for motion images, wherein each frame comprises an array of elemental pixels. In high definition television (HDTV) each frame has approximately two thousand horizontal and one thousand vertical elements; thus, there are approximately two million pixels per frame. Each pixel can be viewed as having a luminance value and a color content that can be described by two numbers. As such, a pixel in a color image can be specified by three numbers. In the conceptually simplest representation, a pixel can be viewed as comprising three sub-pixels: one red, one green, and one blue, where the sum of these three stimuli produces a colored pixel. In the simplest representation at the display level, equal amounts of information are needed to activate each of the sub-pixels. The frame is effectively a super-position of three-color frames, one for each R, G, B sub-frame. Thus the total information required to display in this manner one HDTV frame is in fact three times two million or six million pixels per frame, much in excess of what would be required on the basis of psychophysical color vision data.

Recognition that the human visual system perceives spatial detail primarily through the luminance content, and requires significantly lower spatial resolution for color details is a key element in fully understanding the efficacy of the invention. As such, it is important to point out that color television transmission makes explicit use of the reduced spatial color resolution of human vision, relative to luminance resolution. For the transmission of one full color frame, it is not necessary to transmit three full resolution primary color images. In fact, in the original color television system introduced in the USA and known as the NTSC system, only the brightness, i.e., the luminance information is transmitted at full resolution, and the encoded color information is transmitted at a fraction of that resolution. In actual practice, it was found that human our vision is even more forgiving regarding color spatial resolution than what the NTSC specified. Many analog color television receivers decoded and presented the color information at a fraction of what the transmission standards provided. Thus, in practice, a color television image can have reproduced luminance information at close to 500 pixels per horizontal line, while the color reproduction can have been less than 100 pixels per line.

At the display device level, color image reproduction has always been based on the super-position of three primary color images at full resolution; typically red (R), green (G), and blue (B). The original shadow mask color CRT utilizes three electron guns, one for each primary color. On the screen, with aid of the shadow mask, the three-color images are interspersed on a distance scale that is substantially finer than the effective resolution of the device set by the physical limitations of the electron beams. In LCD and plasma display panels each pixel comprises three color sub-pixels; thus, the three primary color images are superimposed by interspersing them at the subpixel level. In projection displays, typically three primary images are projected onto and thus super-imposed on the viewing screen. Of these primary images, each is created at the full resolution that the system can support, irrespective of whether the primary color images are produced by monochrome CRTs, LCDs, or DLP devices. In some displays, both in projection and direct view, the super-position can occur in the time domain where three sequential color images are projected in rapid succession one after the other, but again, each of these is at full resolution.

In the last few years, direct view LCD flat panel technology emerged as the dominant HDTV display. While public acceptance has been excellent, these devices are less than ideal. They are passive displays needing a backlight to illuminate the LCD panel. The LCD acts like a programmable light shutter. More specifically, each pixel in the LCD direct view panel comprises three sub-pixels; each of these sub-pixels is covered with a small elemental color filter: one for each of the RGB primaries. Each of these sub-pixels is independently programmable by the input signals such that upon white light illumination, each sub-pixel transmits a controlled amount of colored light, which is then integrated by the viewer's eye that acts like a low-pass spatial filter into one perceived color image. Because the LCD system operates by removing light from that provided by the backlight, average power consumption is set by the peak brightness, which leads to excessive energy consumption. To illustrate this point, a direct comparison can be made between a color CRT and an LCD display. In a color CRT, the average brightness and thus the average power consumption is typically ten times lower than the achievable highlight peak brightness and its associated transient power consumption. In a basic CCFL backlit LCD if the same ten to one ratio were to be maintained, the highlight brightness will determine the average required power consumption and on the average 90% of the power consumption will be wasted. In actual operation, LCDs do not provide ten to one highlight to average brightness ratios, and thus their images look less vivid than those of CRTs; nevertheless, even with a compressed brightness ratio, much of the LCD backlight output is wasted.

In addition to power consumption, another problem associated with typical LCDs relates to motion artifacts as mentioned in Background of the Invention. An LCD is a “sample and hold” device, where the image information in each pixel is held for the full frame period. When a moving object is being displayed, the human eye tracks the motion of the object in a continuous manner; the display's “sample and hold” results in the perception of a smear instead of a sharp image of the moving object. For the display of motion, the human eye prefers to see sequences of short pulses, separated by dark periods. This in fact is how most color CRTs operate; their scanning electron beams provide impulse excitation of the phosphor that in turn have light emission decay times much shorter than the frame time. One way to reduce motion artifacts in LCD HDTVs, is to use fast LCD shutters and to introduce black periods, by closing the shutters, in-between the active periods, when the shutters are opened. Of course unless the backlight can also be dimmed during the black period, this practice further reduces the power efficiency of LCD displays.

Yet a third shortcoming of existing LCDs relates to the use of the color filters covering the sub-pixels. Illuminated by white light a red filter necessarily removes, that is, it wastes all the blue and green light falling on it. Likewise, green wastes red and blue, and blue wastes red and green. Therefore approximately two thirds of the incoming light is wasted even under ideal assumptions. In fact, the filter efficiency is more like 20% or less. A known way to eliminate the color filters is to use switchable light sources such that in rapid succession the light source emits the three primary colors. In that case, each LCD pixel only needs to contain a single sub-pixel that sequentially controls the successively available Red, Green, and Blue light to construct the overall color image. This approach works, but produces color break up at the edges of moving objects. Various attempts to reduce color break up have been made, including attempts to increase the rate of the sequential color presentations, and introduction of black periods between sequential color frames.

The invention makes use of the limited color-spatial resolution requirement as set by the human visual system to produce electronic images with improved power efficiency, free of motion artifacts and color break up, in a cost effective manner.

A key enabling feature of the invention is the implementation of low pass filtering accomplished in the electronic domain and further augmented by physical arrangement of the components of the display.

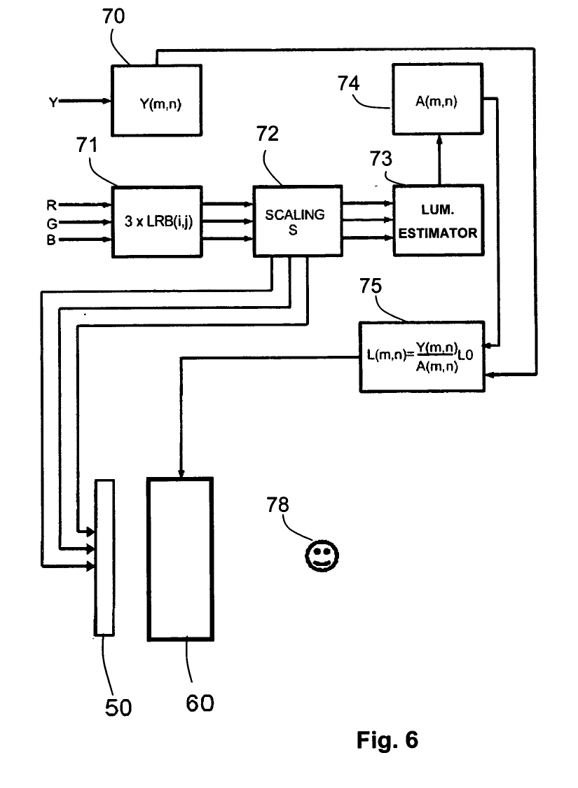

The component of the invention involving the signal processing can be understood with reference to FIG. 6. Here preprocessed video which relays luminance signal Y to luminance controller 70 and a corresponding full resolution color components R,G,B to low pass filter 71.

The incoming luminance signal is preferably digital and can be represented by an array of pixels arranged in M rows by N columns and can be represented symbolically by Y(m,n). Also, the preprocessor (not shown) is designed to properly match M and N to the number of rows and columns in the luminance controlling LCD front end component 60. A typical example would be m=768 and n=1,366. The incoming color signals can be symbolically denoted as R(m,n), G(m,n), B(m,n) representing the three full resolution color components. Further, Y(m,n)=R(m,n)+G(m,n)+B(m,n).

The three full resolution color input signals are passed through low pass filter 71. The low pass filter 71 produces three low resolution digital arrays, 3×LRB(i,j), one each for the three primary color components and each of I rows by J columns, where I and J match the addressable number of rows and columns, respectively, of FED backlight (or low resolution intelligent programmable back light) 50. The three output signals of the low pass filter are delivered to a scaling backlight processor and driver 72, which scales the three output signal by a scale parameter S. The scaling backlight processor and driver 72 also drives the backlight 50, which defines the ultimate display resolution that the viewer 78 will see. The same scaled low pass color signals are also used as inputs to a luminance estimator 73. The luminance estimator 73 calculates the available light luminance value at each LCD pixel. The available light values are stored as an array A(m,n) in array pixel processor 74. The calculation performed by the luminance estimator 73 uses the scaled backlight input signal and the combined point spread function produced at the LCD by the FED backlight 50 and the diffuser in the LCD front end component 60. The input luminance values Y(m,n) are compared to the available light values A(m,n) and the shutter control signal L(m,n) is prepared in shutter driver 75. The shutter control signal L(m,n) to be applied to LCD front end component 60 is obtained by taking the ratio Y(m,n)/A(m,n) multiplied by the value corresponding to the maximum throughput LCD setting Lₒ. Furthermore, if Y(m,n)/A(m,n)>1, then the shutter opening is set to Lₒ. Thus high-light, high-resolution luminance values will saturate at the maximum locally available light. The purpose of the backlight scaling factor S is to minimize such saturations by maximizing available light commensurate with maintaining colorimetric balance requirements.

The backlight scale parameter S is determined by examining the three color components in the output of the low pass filter 71. In this examination, the maximum value obtained is denoted as max(LRB(C)), where C can be either R, or G, or B, whichever has the highest pixel value in its LRB(i,j) array for a given frame. The maximum possible backlight drive level for the thus obtained color primary component C can be denoted MAX(C), commensurate with proper white colorimetric balance. For example, in an 8-bit system, primary luminous flux ratios for white can be R/G/B=30/60/15 and relative luminous efficiencies can be R/G/B=0.5/1.0/0.25. Therefore, having drive current ratios R/G/B=0.6/0.6/0.6=1/1/1, all three primaries have a maximum possible drive MAX(C)=MAX(R)=MAX(G)=MAX(B)=255. Another 8-backlight system can have primaries such that for white the drive current ratios are R/G/B=1.5/1.0/1.2, and then the maximum possible drive values are MAX(R)=255, MAX(G)=170, and MAX(B)=204. The scale parameter S is calculated by evaluating the ratio S=max(LRB(C))/MAX(C). Thus, by scaling the low pass filtered backlight drive signals with scaling parameter S, the backlight is operated at the highest possible brightness level commensurate with the proper color balance. To better understand the significance of the scale parameter S, consider an extreme case where the incoming image frame is mostly black, except for a small bright region covering a cluster of a few pixels. Low pass filtering of a small cluster results in a low level signal, but scaling this low level signal as described above will allow full brightness reproduction.

In a preferred embodiment, each simultaneous backlight unit (SCIBLU) pixels or backlight light unit (BLU) pixel illuminates an area of 3×3 pixels of the light-valve can and BLU sub-pixels outputs are fully color mixed (i.e. no spatial separation of the colored sub-pixels at the optical input plane of the light-valve array). This will produce images with color and luminance resolution equivalent to a conventional light-valve display, where typically each pixel contains three sub-pixels, each with color selective means (e.g. R,G,B color filters). As the BLU pixel count is progressively reduced, small area color detail is lost; specifically, the color saturation of small areas with colors distinct from their surrounds is reduced, but large area color and sharpness reproduction are not significantly affected. One clear counter example, where perceived sharpness would be affected, is image detail based on pure color contrast (PCC). PCC scenes contain patterns where different regions have different colors set to the same luminance value. Such scenes, which cannot be reproduced with black-and-white photography, are virtually never seen in natural scenes and are extremely rare, unless intentionally designed artificially (e.g. computer-generated scenes and images).

Regarding the invention shown in FIG. 2, the controller 62 stores information that enables the description of the low resolution image produced at the optical input plane of the luminance-controlling element (i.e., LCD front end component) 60 by FED backlight (or low resolution intelligent programmable back light operated in simultaneous mode) 50. Errors in this description lead to errors in brightness, contrast, and sharpness. Simulations showed that while differences between reproductions with and without errors in the description of the BLU image at the optical input plane are discernable, the system is error tolerant. In general, it is preferable to err in the direction where the controller 62 assumes a lower resolution BLU image than the actually-produced BLU image, rather than erring in the opposite direction. To clarify this point, first consider an extreme limit case where the controller 62 is programmed under the assumption that the luminance content of the BLU image fully matches all details of the luminance content of the incoming signal, while the actual BLU image is in fact a low resolution image. In that case, the controller 62 would make no adjustment to the image produced by the BLU, the controller 62 will fully open all shutter pixels in LCD front end component 60, and the resulting image sharpness would be what the BLU actually produced. Next consider the opposite extreme case, where the programming assumption of controller 62 is that BLU 60 produces no luminance spatial detail whatsoever. In this case, controller 62 will send a complete grey scale image to LCD front end component 60. While this would introduce brightness and contrast errors, the reproduced image will be fully recognizable.

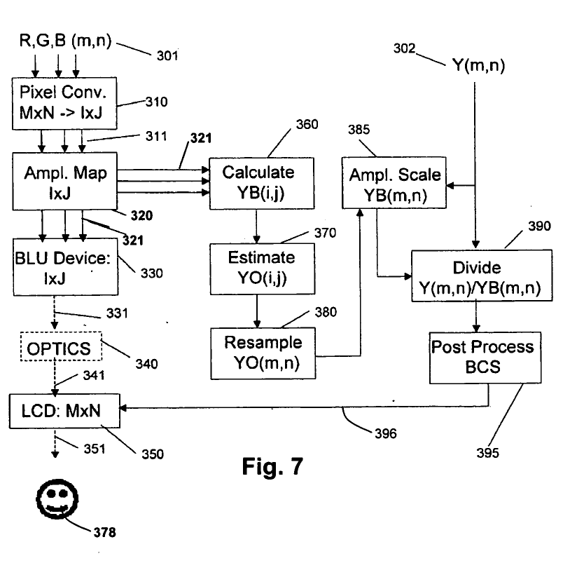

Details of the signal flow and control algorithm according to the invention can now be best understood with the aid of FIG. 7, wherein a LCD front end component 350 and BLU device 330 are shown. Here the tricolor input signal 301 is fed to pixel converter 310, where the M×N input matrix is reduced to an I×J matrix, where the 1×J matrix matches the pixel structure of BLU device 330. According to the invention herein described, it is preferable to have the I×J matrix being 9 to 500 times smaller than the M×N matrix. Each pixel in the input is represented, for example, by an 8-bit digital value. The range of the pixel indices is 1<m<M and 1<n<N. Thus tricolor input signal 301 has 3×M×N sub-pixel values for each frame. To avoid aliasing, the pixel count reduction is typically a two-step process, whereby the input is first low pass filtered and subsequently pixelized. The output of the pixel converter 310 is a reduced matrix tri-color signal 311, which is fed to an amplitude mapping element 320. The purpose of element 320 is to compensate for loss of highlight brightness that is a direct consequence of the low pass operation in pixel converter 310. Element 320 can be designed to scale up the i,j pixel values of the reduced I×J matrix according local single pixel based, or global frame based, or regional multi pixel based rules, subject to the constraint that color errors are minimized. For example, based on simulation studies, a simple non-linear transformation of the type value−out=Sx(value−in), where S=[(value−in)/Max]^{r}, 0<r<1, and MAX is the maximum possible signal value (Max=255 for an 8-bit system) can be effectively used.

A preprocessor, not shown in FIG. 7, provides the luminance signal 302 of each pixel, Y(m,n), corresponding to each pixel's color signal R,G,B(m,n). The backlight 331 propagate into the optical stack 340 which can include a diffuser and polarizer. The light 341 exiting the optical stack 340 enters the LCD front end component 350 which appropriately controls the light 341 to provide the image light 351 to the viewer 378.

The three-primary reduced matrix signal 321 is fed to the tricolor BLU Device 330. Device 330 produces a reduced resolution tricolor image, emitting light 331 that upon passing through optics 340 is projected as light pattern 341 on the optical input plane of monochrome LCD panel 350. LCD control signal 396 is derived from the reduced matrix color signals 321, from luminance input signal 302, and from the previously determined and stored properties of the BLU and the optics referred to hereafter as BLU-optics. Mathematically, the BLU input signals 311 produce a deterministic BLU optical output at each BLU pixel, and this output produces a deterministic pattern at the LCD optical input plane. In general, a computationally intensive convolution calculation can produce the desired BLU-optics information. In practice, a much simpler low-pass filtering based on the imaging properties of optics 340 can be employed.

To determine LCD drive signal 396, the luminance values YB(i,j) of the BLU drive signals are calculated in calculator element 360. The output of calculator element 360 is fed to optical estimator element 370, where the BLU-produced luminance distribution at the LCD (light valve) optical input plane YO(i,j) is estimated based on the BLU-optics information as described above. In resample element 380, the reduced matrix YO(i,j) luminance distribution information is re-sampled to obtain full resolution luminance distribution YO(m,n). Scale element 385 performs additional linear scaling of YO(m,n) such that the maximum value of the backlight luminance estimate matches the maximum value of the input luminance Y(m,n). Since noise can introduce single pixel false maxima and perceptually single pixel maxima are not significant, this scaling is preferably based on large area highlight pixel clusters in Y(m,n) approximately comprising 100 contiguous bright pixels. The scaled backlight luminance estimate YB(m,n) is fed to dividing element 390, where the ratio Y(m,n)/YB(m,n) is calculated. This ratio is understood to be that when it is equal to unity, the luminance controlling pixel is 100% transmissive. Following the divide operation, additional image adjustments can be done in post-processing element 395 to produce according to viewer preference brightness-contrast-sharpness (BCS) optimization.

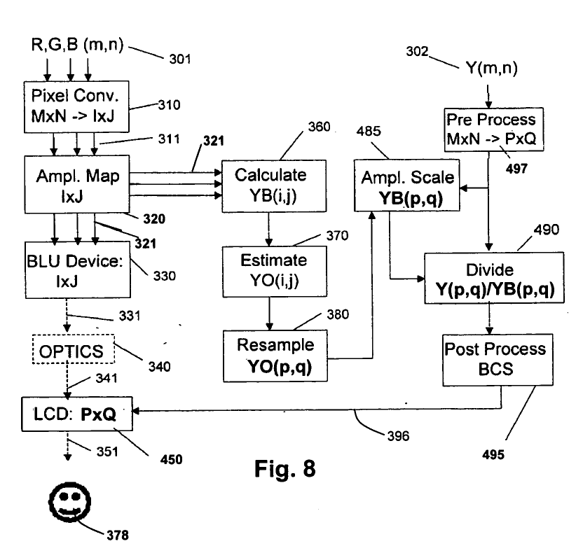

With reference to FIG. 8, a novel inventive system is described. Shown here is a system where the luminance-controlling LCD element (i.e. the LCD front end component 450) has a pixel count P×Q that is different from the input pixel count M×N. For example, M×N=768×1366 and P×Q=768×4098. In this case, the luminance signal 302 is re-scaled by a preprocessing element 497 to produce a P×Q luminance matrix, which is greater than M×N, thereby increasing the number of pixels by a factor of three. Basically, the elements here are the same as those in FIG. 7. The optical estimator element 370 of FIG. 7 corresponds to the optical estimator element 470, the resample element 380 corresponds to the resample element 480, the scale element 385 corresponds to the scale element 485, the dividing element 390 corresponds to the dividing element 490, and post-processing element 395 corresponds to post-processing element 495.

The concept described with reference to FIG. 8 is that there is an opportunity of having the picture luminance resolution being three times greater than that of a conventional LCD display with color filters. The reason is each pixel in a conventional LCD contains three adjacent liquid crystal cells to provide the proper colorimetric content for the pixel. In other words, in a pixel, one cell is needed for red, one is needed for blue and one is needed for green. However, the same colorimetric content in the novel device is provided through one liquid crystal cell which can be the exact same size as the liquid crystal cells in a conventional display. The reason is the backlight provides the programmed light of proper colorimetric content to each liquid crystal cell in the novel display. Therefore, in the novel display, groupings of three adjacent LCD pixels can correspond to one pixel of video content, such that the pitch of the groupings can define a screen resolution which will correlate to the resolution in the conventional LCD. Alternatively, in the novel display, the three adjacent LCD pixels that would correspond to one pixel of video content, can each correspond as a unique pixel that is distinguished from it neighboring cells in terms of color content and luminance, whereby the front end component 450 allows the display to receive higher definition video signal and display higher definition images (i.e., three times greater definition than conventional display). The novel display can be designed such that the viewer, according to his/her preference can either select to have individual liquid crystal cells each correspond to a unique pixels, which would be a high resolution mode capable of taking advantage of high definition video or the viewer can select to have groupings of liquid crystal cells, which would be a lower resolution.

A key advantage of the systems described herein is that it produces significant energy saving in operating power requirements relative to other known systems, without undesirable dynamic effects. The following table provides comparative power consumption estimates. The power savings are the result of the intelligent backlight programming and the separation of the color reproducing and luminance controlling functions and elements. This separation can be achieved with both color sequential and simultaneous color BLU. The simultaneous color system described in this invention is both power-efficient and free of color breakup.

32″ LCDTV PANEL SYSTEM AVERAGE POWER CONSUMPTION COMPARISON ESTIMATES

| | | | LCD | | | | | |
|---|---|---|---|---|---|---|---|---|
| BLU | | | Color | | | Avg. Power | | |
| TECHNOLOGY | TYPE | SPEED | Filter | SPEED | MOTION | REL. EFF.* | Nits/W | W @500 Nits |
| CCFL | WHITE | DC | YES | STD. (60/Sec) | SMEARED | REF. | 4 | 125 |
| CNTIBLU | WHITE | STD. (60/Sec) | YES | STD. (60/Sec) | CRT LIKE** | 4 | 16 | 31 |
| CNT/BLU | COLOR SEQ | 3 × STD. (180/Sec) | NO | 3 × STD. (180/Sec) | *** | 18 | 72 | 7 |
| CNT1BLU | SCIBLU | STD. (60/Sec) | NO | STD. (60/Sec) | CRT LIKE** | 18 | 72 | 7 |

*Assuming a typical image with peak-power/average-power = 10 and luminous efficiency (CCFL)/luminous efficiency (CNT/BLU) = 2.5.
**Good motion reproduction standard reference.
***Depends on BLU drive characteristics and frame rate; typically color breakup that is noticeable by most observers.

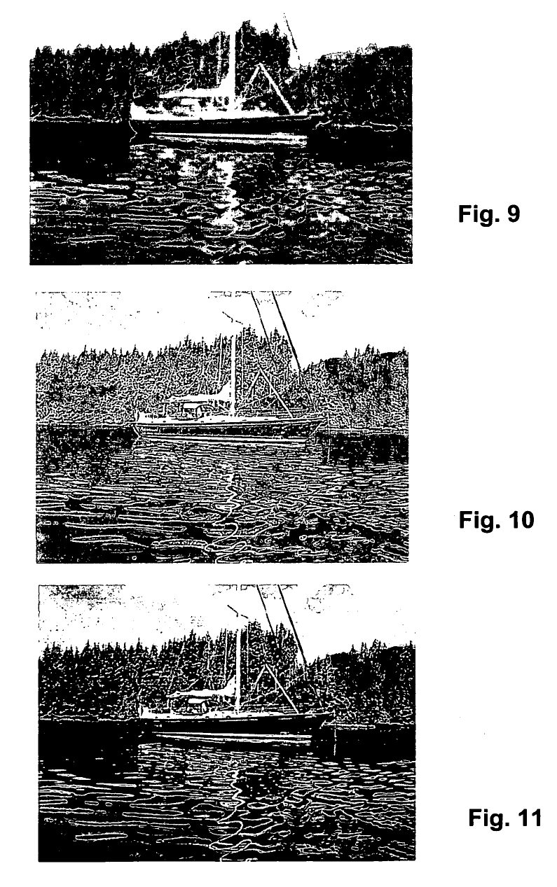

FIGS. 9-11 attempt to illustrate the effectiveness of the invention. FIG. 9 represents in black and white a representation of the low resolution plan view image of color content of a frame of video from tricolor backlighting according to the invention. FIG. 10 is a representation of the full resolution plan view image of luminance content from the same frame of video used in FIG. 9 from the luminance controlling front-end. FIG. 11 is the resultant full resolution viewable color image after combining the luminance controlling front-end and color content controlling backlighting components for the frame of video used in FIGS. 9 and 10. In this example, the low resolution plan view image of color content was generated by running full resolution color information through a low pass filter to obtain a smaller matrix of color content commensurate with a reduced number of color emitting cells in the backlight. From the actual images (in color) of those in FIG. 9-12, one can see that high quality, high definition images with the correct calorimetric content can be made employing a low cost, simple multicolor backlight having significantly fewer color pixel cells as used in direct view type display devices.

A preferred method of displaying video images according to the invention comprises the steps of low-pass filtering a full resolution color RGB information, thereby producing low resolution color information; scaling the low resolution color information based on local color components by a local scaling parameter, wherein a dominant local low resolution color information is scale to a maximum possible luminance for color components, while maintaining predetermine colorimetry; and accordingly driving individual color elements in repeat units of the low resolution multicolor backlight unit.

Although the embodiments show applications of the invention which use LCD front-end components for controlling luminance and an FED backlight for controlling tricolor content, it should be pointed that the invention includes examples of other types of front-end components having neutral or monochrome light valves to define the display resolution and control luminance or other types of intelligent backlighting to provide separate and distinct color. For example, air gap autogenesis cells or optical switches would be examples of other types of front-end components. Also, LEDs would be an example of other types of backlight device for controlling tricolor content. Additionally, although reference is made to tricolor backlighting, backlights that use more than three colors are also embodiments of the invention.

1. A display comprising:
a front-end component having a plurality of neutral light valves, the neutral light valves defining the display resolution;
a backlight unit having plurality of individual elements grouped into repeat units, the individual elements in the repeat units differ in color, the repeat units have a resolution less than the display resolution, the individual elements in individual repeat units emit light in a non-color sequential manner incident on more than one neutral light valve;
a low pass-filter that receives and filters a full resolution color RGB information of video to produce filtered low resolution color information; and
a scaled backlight drive receives the filtered low resolution color information and scales local color components by a local scaling parameter, the scaled backlight drive correlates a dominant local low resolution color information to maximum possible luminance for the color components and accordingly drives the individual elements in the individual repeat units.

2. The display of claim 1, wherein the individual elements simultaneously emit light.

3. The display of claim 2, wherein the light valves control luminance.

4. The display of claim 3, wherein the light valves are programmable.

5. The display of claim 4, wherein the backlight unit is a tricolor system.

6. The display of claim 5, wherein the backlight unit uses phosphor material which decay in a timeframe shorter than a frame period.

7. The display of claim 6, wherein the backlight unit is a field emission device.

8. The display of claim 7, wherein the front-end component is a liquid crystal device.

9. The display of claim 2, wherein the backlight is a programmable field emission device and the front-end component is a liquid crystal device.

10. A method for displaying video images in a display having a low resolution multicolor backlight unit and a network of neutral light valves that define a resolution of the display, comprising the steps of:
low-pass filtering a full resolution color RGB information, thereby producing low resolution color information;
scaling the low resolution color information based on local color components by a local scaling parameter, wherein a dominant local low resolution color information is scaled to a maximum possible luminance for color components, while maintaining predetermined colorimetry; and
accordingly driving individual color elements in repeat units of the low resolution multicolor backlight unit.
